(19) United States
(12) Patent Application Publication
(10) Pub. No.: US 2020/0332977 A1
(43) Pub. Date: Oct. 22, 2020

(54) Light Module for a Motor Vehicle Headlamp

(71) Applicant: ZKW Group GmbH, Wieslburg (AT)

(72) Inventors: Stefan MIEDLER, Unterradlberg (AT); Peter SCHADENHOFER, Roggendorf (AT); Markus REINPRECHT, Pielachhäuser (AT)

(21) Appl. No.: 16/760,714

(22) PCT Filed: Nov. 13, 2018
(86) PCT No.: PCT/EP2018/081023

§ 371 Date: Apr. 30, 2020

(30) Foreign Application Priority Data
Nov. 21, 2017 (EP) 17202776.5

(51) Int. Cl. F21S 41/265; F21S 41/64; F21S 41/153; G02B 27/30; F21S 41/143

(52) U.S. Cl. CPC F21S 41/265; F21S 41/645; F21Y 2113/10; G02B 27/30; F21S 41/143; F21S 41/153

(57) ABSTRACT

The invention relates to a light module for a motor vehicle headlamp comprising at least one light source (2) and at least one optical imaging system (3) which images light generated by the at least one light source (2) into a region in front of the light module (1) in the form of at least one light distribution of a predefined type. The optical imaging system 93) comprises an entry optical unit (31), an exit optical unit (32), and at least one beam-shaping device (33), which beam-shaping device (33) is arranged between the entry optical unit (31) and the exit optical unit (32). The entry optical unit (31) is designed to capture the light generated by the at least one light source (2) and to conduct it in the form of a plurality of light beams in the direction of the beam-shaping device (33), the beam-shaping device (33) is designed to shape the plurality of light beams to form at least one intermediate image of a predefined type, and the exit optical unit (32) is designed to project the at least one intermediate image of a predefined type in the form of at least one light distribution of a predefined type into a region in front of the light module (1). The beam-shaping device (33) is formed as a continuous layer extending in a plane perpendicular to the optical axis (OA) of the optical imaging system (3), which continuous layer is controllable in respect of its transparency. In addition, the total amount of light penetrating from the entry optical unit (31) to the exit optical unit (32) can be influenced by adjusting the transparency of the continuous layer.

The invention relates to a light module for a motor vehicle headlamp, which light module comprises at least one light source and at least one optical imaging system, which optical imaging system images light generated by the at least one light source into a region in front of the light module in the form of at least one light distribution of a predefined type, wherein the optical imaging system has an entry optical unit, an exit optical unit and at least one beam-shaping device, which beam-shaping device is arranged between the entry optical unit and the exit optical unit, wherein the entry optical unit is set up to capture the light generated by the at least one light source and to conduct the same in the form of a plurality of light bundles in the direction of the beam-shaping device, the beam-shaping device is set up to shape the plurality of light bundles to form at least one intermediate image of a predefined type, and the exit optical unit is set up to project the at least one intermediate image of a predefined type, in the form of the at least one light distribution of a predefined type, into the one region in front of the light module, preferably onto the carriageway.

In addition, the invention relates to a motor vehicle headlamp having at least one such light module.

Light modules of the above-mentioned type are known from the prior art. The international application of the applicant, WO 2015/058227 A1, shows a microprojection light module for a motor vehicle headlamp, comprising at least one light source and at least one projection device, which images the light exiting from the at least one light source into a region in front of the motor vehicle in the form of at least one light distribution, wherein the projection device comprises: an entry optical unit, which consists of an array of micro-entry optical units; an exit optical unit, which consists of an array of micro-exit optical units, wherein precisely one micro-exit optical unit is assigned to each micro-entry optical unit, wherein the micro-entry optical units are constructed in such a manner and/or the micro-entry optical units and the micro-exit optical units are arranged in such a manner with respect to one another, that light exiting from a micro-entry optical unit only enters precisely into the assigned micro-exit optical unit, and wherein the light pre-shaped by the micro-entry optical units is imaged by the micro-exit optical units into a region in front of the motor vehicle as at least one light distribution.

In the international application of the applicant, WO 2017/066817 A1, a microprojection light module for a vehicle headlamp is thematized, which comprises at least one light source and at least one projection device, which images the light exiting from the at least one light source into a region in front of the motor vehicle in the form of at least one light distribution, wherein the projection device has an entry optical unit, which has one, two or more micro-entry optical units, which are preferably arranged in an array, and an exit optical unit, which has one, two or more micro-exit optical units, which are preferably arranged in an array, wherein precisely one micro-exit optical unit is assigned to each micro-entry optical unit, wherein the micro-entry optical units are constructed in such a manner and/or the micro-entry optical units and the micro-exit optical units are arranged in such a manner with respect to one another, that essentially the total light exiting from a micro-entry optical unit only enters precisely into the assigned micro-exit optical unit, and wherein the light pre-shaped by the micro-entry optical units is imaged by the micro-exit optical units into a region in front of the motor vehicle as at least one light distribution.

Furthermore, the international application of the applicant, WO 2017/066818 A1, shows a microprojection light module for a motor vehicle headlamp, comprising at least one light source and at least one projection device, which images the light exiting from the at least one light source into a region in front of the motor vehicle in the form of at least one light distribution, wherein the projection device comprises an entry optical unit, which has one, two or more micro-entry optical units, which are preferably arranged in an array, an exit optical unit, which has one, two or more micro-exit optical units, which are preferably arranged in an array, wherein precisely one micro-exit optical unit is assigned to each micro-entry optical unit, wherein the micro-entry optical units are constructed in such a manner and/or the micro-entry optical units and the micro-exit optical units are arranged in such a manner with respect to one another, that essentially the total light exiting from a micro-entry optical unit only enters precisely into the assigned micro-exit optical unit, and wherein the light pre-shaped by the micro-entry optical units is imaged by the micro-exit optical units into a region in front of the motor vehicle as at least one light distribution, wherein a first screen device is arranged between the entry optical unit and the exit optical unit.

Furthermore, it is sufficiently known that not exactly one micro-exit optical unit has to be assigned to each micro-entry optical unit. By contrast, each micro-entry optical unit and/or micro-exit optical unit may be subdivided into a plurality of “micro-micro optical units” (cf. WO 2015/058227 A1, page 19, paragraph 4, WO 2017/066817 A1, page 21, paragraph 3, WO 2017/066818 A1, page 19, last paragraph).

One disadvantage of the above-mentioned light modules is that only a very limited number of light distributions or light functions can be realized using a single light module (low efficiency). For example, screens (illumination devices) are used for realizing dynamic (changeable) main light functions, which screens are mechanically movable with regards to the optical units (entry optical unit and/or exit optical unit). This may be realized using an actuator for example, which is assigned to the screen(s) and/or the optical unit(s). However, after the relevant illumination devices in terms of lighting engineering have been produced in such a manner that the screens are applied with the aid of coating methods onto supports (glass plates) provided therefor, dynamic changing of the light image is only possible to a very limited extent.

It is an object of the present invention to create a light module for generating a dynamic light distribution with an improved efficiency. The object is achieved using a light module of the above-mentioned type, in that the beam-shaping device is constructed as a continuous layer extending in a plane which is transverse to the optical axis of the optical imaging system, which continuous layer is controllable with regards to its transparency and the total light quantity penetrating from the entry optical unit to the exit optical unit can be influenced by adjusting the transparency of the continuous layer, wherein the continuous layer has one, two or more segments lying in the same plane, wherein each individual segment is controllable independently of the other segments with regards to its transparency, wherein the entry optical unit is constructed as a multiplicity of micro-entry optical units, the exit optical unit is constructed as a multiplicity of micro-exit optical units, wherein the micro-entry optical units and the micro-exit optical units are assigned to one another in groups, and define a multiplicity of optical micro-imaging systems, wherein each optical micro-imaging system comprises a group of micro-entry optical units, a group of micro-exit optical units and at least one segment of the continuous layer, which is controllable with regards to its transparency, wherein the light module comprises a plurality of light sources which are controllable independently of one another, wherein at least a first part of the segments is set up to generate a light distribution of a first predefined type, and at least one second part of the segments is set up to generate a light distribution of a second predefined type. This implies that the control of the corresponding (first, second, third, etc.) part of the segments is adapted to the control of the light source(s) assigned to this part of the segments, in order to generate a light distribution of the corresponding type (the first, the second, the third, etc.). At least one of the light sources, which are controllable independently of one another, is assigned to each part of the segments, wherein different parts/groups of the segments are assigned to different light sources, in order to facilitate the control. That is to say each part of the segments is only irradiated by the at least one light source assigned to this part of the segments, as a result of which, a light distribution of a predefined type is generated. This assignment also brings the advantage that the light sources, which are controllable independently of one another, may have a different power. For example, the light sources, which are assigned to the part of the segments set up for generating an indicator light distribution, may be less strong than the light sources, which are assigned to the part of the segments set up for generating a dipped-beam distribution.

The generation of light distributions of various types (first type, second type, and so on) preferably takes place in a correlated manner. As explained in the following, various scenarios may be realized in this case. For example, the main-beam distribution may be switched off (main-beam distribution part is inactive) when passing a town boundary and a welcome light distribution or, depending on the situation, a warning light distribution may be activated at the same time. It is expedient to adapt the control of every part of the segments to the control of the light source(s) assigned to this part of the segments or the micro-imaging systems.

In connection with the present invention, the term “light distribution of a predefined type” is understood to mean a light distribution radiated by a motor vehicle headlamp, which corresponds to a light function of a motor vehicle headlamp (main beam, dipped beam, cornering light, indicator, etc.) and preferably corresponds to a legal standard.

One such light module for example has a plurality of main light functions, which may be changed (switched between one another) during the operation of the light module.

It may be provided that the continuous layer is constructed as a liquid crystal layer, for example a liquid crystal display.

Furthermore, it may be expedient if all segments lie in a vertical plane and preferably adjoin one another. For example, one segment may be constructed a pixel of the liquid crystal display.

The terms “vertical” and “horizontal” relate to a specialist, expedient installation position of the light module in a motor vehicle headlamp if this motor vehicle headlamp is in an operational position. In this case, the operational position is understood to mean the position in which the motor vehicle headlamp is installed in a motor vehicle or for example is subjected to an investigation in a lighting-engineering laboratory of a light distribution radiated by the motor vehicle headlamp.

Expediently, it may be provided that each individual segment comprises at least one subsegment and the at least one subsegment is controllable with regards to its transparency.

It is additionally advantageous if each individual segment comprises two or more, preferably five, subsegments, which lie in the same plane and preferably adjoin one another, wherein the subsegments are controllable independently of one another.

Further advantages result if the subsegments have a different shape and/or size.

Furthermore, it may be expedient if each micro-imaging system has precisely one micro-entry optical unit, precisely one micro-exit optical unit and precisely one segment of the continuous layer, which is controllable with regards to its transparency.

Usually, an LCD (liquid crystal display) consists of individual rectangular pixels, from which the desired light image can be composed. It is disadvantageous in this case that a very high resolution (approx. 10000 to 14000 ppi, for example 12700 ppi) would be necessary using rectangular pixels, in order to create a dipped-beam distribution or main-beam distribution, for example. This would be the case for example if the desired light image—an overall light distribution, such as dipped-beam distribution or main-beam distribution—is created as a totality of individual micro-light images, wherein the micro-light images are generated by a system made up of a micro-entry optical unit, a micro-exit optical unit and a screen lying therebetween. If one were then to use the continuous layer, for example the liquid crystal display, as a screen, this would require a very high resolution from the liquid crystal display, as described above.

Therefore, it may be advantageous if the individual segments and/or subsegments have a shape and/or size, which correspond(s) to a part of the light distribution to be generated in each case. One may say that a segment or subsegment corresponds to a pixel and the pixels are individually controllable.

A further advantage results, if a collimator is installed upstream of each light source and each light source is set up for generating a predefined light distribution. Furthermore, it may be advantageous that a polarizing element, for example a polarizing beam splitter, is provided between the light source, for example the LED light source, and the micro-imaging system and/or the continuous layer, for example liquid crystal display, to generate linearly polarized light. It may be expedient to arrange the collimator between the light source and the entry optical unit, so that the light hits the entry optical unit in the form of parallel light beams.

In addition, it may be provided that the light sources are arranged on a printed circuit board, which is preferably arranged transversely to a main radiation axis of the light module, for example form a 4×3 matrix-like arrangement, and preferably radiate light in different colours.

It is particularly advantageous if the light module is set up to generate a plurality of light distributions, wherein the type of each light distribution is chosen from the following list of types:
cornering light distribution;
town light distribution;
country light distribution;
motorway light distribution;
light distribution for booster light for motorway light;
cornering-beam light distribution;
dipped-beam light distribution;
near field dipped-beam light distribution;
light distribution for asymmetric far field dipped beam;
light distribution for asymmetric far field dipped beam in cornering-beam mode;
main-beam light distribution;
indicator light distribution;
position light distribution;
anti-glare main-beam light distribution;
flashing-light-sequence-effect light distribution.

Furthermore, it may advantageously be provided that a control device is assigned to the light module, which control device is set up to control the transparency of the continuous layer, wherein the control device is preferably arranged in the light module.

The invention is explained in more detail in the following on the basis of exemplary non-limiting embodiments, which are shown in a drawing. In the figures:

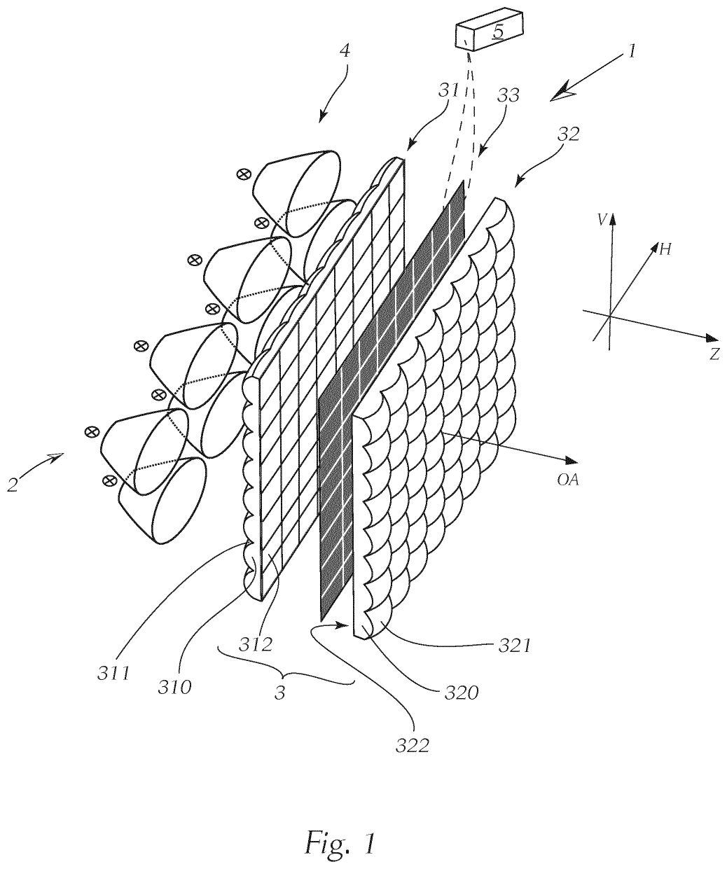

FIG. 1 shows a motor-vehicle headlamp light module having an optical imaging system with at least one beam-shaping device, and

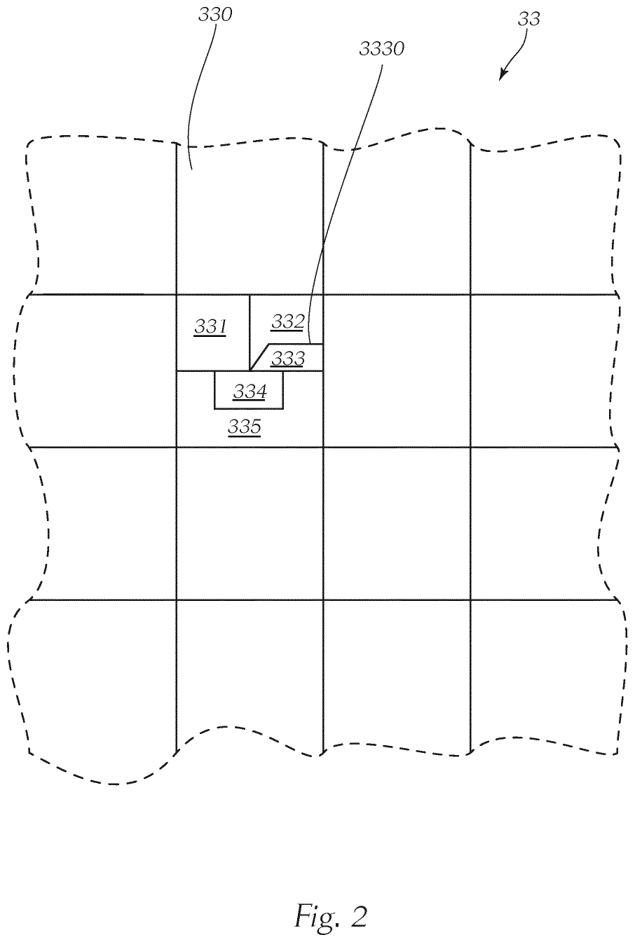

FIG. 2 shows a continuous layer constructed as a liquid crystal display, with segments having subsegments.

First, reference is made to FIG. 1. This shows a motor-vehicle headlamp light module 1, which corresponds to the light module according to the invention. The motor-vehicle headlamp light module 1 comprises a plurality of light sources 2. FIG. 1 shows eight light sources 2 and can for example be arranged or installed in a motor vehicle headlamp (not shown here).

Furthermore, the motor-vehicle headlamp light module 1 comprises an optical imaging system 3, which images (essentially all of) the light generated by the light sources 2 (when the light sources 2 are switched on) in the form of at least one light distribution of a predefined type into a region in front of the motor-vehicle headlamp light module 1, that is to say in the direction Z, which direction Z matches the forward travel direction of a motor vehicle, if the motor-vehicle headlamp light module 1 is located in a proper installation position in a motor vehicle. The direction Z may for example run parallel to the optical axis OA or to the main radiation axis of the motor-vehicle headlamp light module. The main radiation direction preferably coincides with the optical axis OA (and with the direction Z). The light sources 2 may for example be constructed as LED light sources, which LED light sources are preferably arranged on a printed circuit board (not shown). The printed circuit board is expediently transverse to the optical axis OA of the motor-vehicle headlamp light module 1. The light generated by the switched-on light sources 2 may be captured by the optionally provided collimators 4 and conducted in the form of parallel light in the direction of the optical imaging system 3.

The optical imaging system 3 has an entry optical unit 31, an exit optical unit 32, and at least one beam-shaping device 33. The beam-shaping device 33 is arranged in the main radiation direction (parallel to the direction Z), downstream of the entry optical unit 31 and upstream of the exit optical unit 32—that is to say between the entry optical unit 31 and the exit optical unit 32. It can be drawn from FIG. 1, that the entry optical unit 31, the exit optical unit 32 and the at least one beam-shaping device 33 are preferably arranged in planes, which essentially lie parallel to one another and are perpendicular to the direction Z (vertical). The entry optical unit 31 is set up to capture (essentially all of, i.e. without great losses) light of the light sources 2, and to conduct the same in the direction of the beam-shaping device 33 in the form of a plurality of light bundles. As mentioned previously, the light of the light sources 2 may be collimated by one or more collimators 4, before it hits the entry optical unit 31. The entry optical unit 31 may be constructed as a micro-entry-optical-unit array made up of a plurality of micro-entry optical units 310 arranged in a matrix-like manner in the same plane (in the (vertical) plane of the entry optical unit 31). Such micro-entry-optical-unit arrays have already been thematized in a few applications of the applicant cited in the description introduction (WO 2015/058227 A1; WO 2017/066817 A1; WO 2017/066818 A1). Reference is made to the corresponding points in these applications for further details relating to micro-entry-optical-unit arrays, which are hereby incorporated into the current application. Each micro-entry optical unit 310 has a light entry side 311 facing the light sources 2 and a light exit side 312 facing away from the light sources 2. FIG. 1 shows micro-entry optical units 310, wherein each micro-entry optical unit 310 has an approximately plane, for example rectangular, particularly square light exit side 312 and a curved, approximately convexly curved light entry side 311. At this point, it is noted that a just described configuration of the light entry and light exit sides of the micro-entry optical units is not obligatory. As is already known for example from the application WO 2017/066817 A1, it may be advantageous to construct the light entry sides 311 in an approximately plane manner and the light exit sides 312 in a curved manner. At least one effect of the entry optical unit 31 is to split and pre-shape the light radiated by the light sources 2.

The light which is split into a plurality of light bundles and pre-shaped hits the beam-shaping device 33. At least one property of the beam-shaping device 33 is that the same shapes the plurality of light bundles to form at least one intermediate image of a predefined type. In this case, the beam-shaping device 33 is preferably arranged in a focal plane of the exit optical unit 32. As is known from the above-listed prior art, this shaping may for example take place with the aid of screen devices, which may be constructed for example as a metal layer with a plurality of openings, which have optically active edges. In this case, the light hitting such an illumination device passes through the openings unhindered. If the light hits a non-penetrated region of the illumination device, then it is reflected. By shaping the openings and in particular the shape and the course of the optically active edges, it is possible to influence the generated light distribution. For further details, reference is likewise made to the documents (WO 2015/058227 A1; WO 2017/066817 A1; WO 2017/066818 A1).

Before a beam-shaping device, which corresponds to the beam-shaping device according to the invention, is covered, the properties and the shape of the exit optical unit 32 shown in FIG. 1 should be outlined briefly.

The exit optical unit 32 may be constructed as a micro-exit-optical-unit array, which is made up of a plurality of micro-exit optical units 320 arranged in a matrix-like manner in the same plane. Such micro-exit-optical-unit arrays have already been thematized in a few applications of the applicant cited in the description introduction (WO 2015/058227 A1; WO 2017/066817 A1; WO 2017/066818 A1). Reference is made to the corresponding points in these applications for further details relating to micro-entry-optical-unit arrays, which are hereby incorporated into the current application. Each micro-exit optical unit 320 has a, preferably plane, for example rectangular, particularly square light entry side 321 facing the light sources 2 and the light exit sides 312 of the micro-entry optical units 310 and a, preferably curved, for example convex, light exit side 322 facing away from the light sources 2 and the light exit sides 312 of the micro-entry optical units 310. The exit optical unit 32 is set up to project the at least one intermediate image of a predefined type in the form of the at least one light distribution of a predefined type into the one region in front of the motor-vehicle headlamp light module 1.

According to the invention, the beam-shaping device 33 is constructed as a continuous layer extending in a plane which is transverse to the optical axis OA of the optical imaging system 3 (and the motor-vehicle headlamp light module 1). The term “continuous” for example means that the layer does not have any openings like the illumination devices known from the prior art. The plane, in which the continuous layer 33 extends, is preferably arranged parallel to the planes in which the entry optical unit 31 and the exit optical unit 32 lie. One of the preferred properties of the optical imaging system 3 is that the entry optical unit 31, the exit optical unit 32 and the continuous layer 33 are arranged in planes which lie parallel to one another and normal to the optical axis OA. A further preferred property of the optical imaging system 3 is that the continuous layer 33 is arranged between the entry optical unit 31 and the exit optical unit 32 in or close to the intermediate-image plane, preferably in or close to the focal plane of the exit optical unit 32. Furthermore, it is advantageous if the continuous layer 33 is arranged in such a manner that all of the light of the light sources 2 bundled and/or pre-shaped by the entry optical unit 31 is used by the continuous layer 33 for shaping the intermediate image. It is emphasized at this point, that these properties of the optical imaging system 3 may not only characterize the motor-vehicle headlamp light module 1 illustrated in FIG. 1, but also other embodiments of the present invention.

The continuous layer 33 is controllable with regards to its transparency. The term transparency relates to the property of the continuous layer 33 to let through electromagnetic waves, preferably light in a spectral range which is visible for humans. It is expedient if the transparency of the continuous layer 33 is adjustable in a large range, that is to say from non-light-permeable—the light quantity penetrating to the exit optical unit 32 is essentially reduced to zero—up to absolutely transparent—all light is let through by the entry optical unit 31 to the exit optical unit 32. Furthermore, it is advantageous if the continuous layer 33 is controllable with regards to its transparency in certain regions. That is to say the continuous layer may be controllable in such a manner that it, for example, allows light through partially or completely in predefined regions, and blocks the light in the other, likewise predefined regions. The regions and the control of the continuous layer 33 may take place by means of a control device 5 (dashed lines) assigned to the motor-vehicle headlamp light module 1 or arranged in the same. The control device 5 may for example comprise a storage medium having a software program which can be executed by the control device 5, which software program correspondingly controls the continuous layer 33 with regards to its transparency, when the program is executed. By, for example, control by region of the transparency of the continuous layer 33, the intermediate image and consequently the generated light image (light distribution) can be modified. For example, certain regions may be dimmed or brightened, depending on the purpose and type of the light distribution. The type of a radiated light distribution can likewise be changed by control. The continuous layer 33 may therefore be used like a “screen”, the screen edges of which can be changed in accordance with the segments which are controlled with respect to their transparency.

The continuous layer 33 shown in FIG. 1 may also be constructed as a support for the entry optical unit 31 and the exit optical unit 32. For example, the continuous layer 33 may be surrounded on both sides—both from a side facing the entry optical unit 31 and from a side facing the exit optical unit 32—by glass plates or embedded into these glass plates, wherein these glass plates function as supports for the entry optical unit 31 and the exit optical unit 32 in each case. For example, during the production of the optical imaging system 3, the entry optical unit 31 and the exit optical unit 32 may be applied to the glass plates, for example by bonding using a UV-curing adhesive.

The continuous layer 33 is preferably constructed as a liquid crystal layer, for example a liquid crystal display. In this case, the person skilled in the art understands that a liquid crystal display also contains corresponding polarizers in addition to the liquid crystal layer.

The continuous layer according to the invention is preferably constructed as a liquid crystal display. FIG. 2 shows a continuous layer 33 constructed as a liquid crystal display. This layer may for example be used in the optical imaging system 3 shown in FIG. 1. For this reason, the same reference number is used for the continuous layer. The continuous layer 33 has a plurality of square segments, for example liquid crystal display segments 330, which lie in the same plane and preferably adjoin one another. It is understood that the segments 330 do not have to be square. However, it is expedient if the shape of the segments 330 is adapted to the shape of the base surfaces of the light exit sides 312 of the micro-entry optical units 310 and to the shape of the base surfaces of the light entry sides 322 of the micro-exit optical units 320. In this manner, a micro-entry optical unit 310, a micro-exit optical unit 320 assigned to the same and a segment 330 lying therebetween are combined to form a micro-optical system corresponding to a micro-imaging system according to the invention. It is understood, that, for example, a convexly or concavely constructed light entry side or light exit side of a lens, for example a micro-entry optical unit or a micro-exit optical unit, may be square. FIG. 1 shows this for example.

Furthermore, it is expedient if the entry optical unit 31, exit optical unit 32 and the continuous layer 33 are arranged and/or positioned in such a manner with respect to one another, that precisely one segment 330 and one micro-exit optical unit 320 correspond to each micro-entry optical unit 310. In this case, it is expedient if the optical axes of the mutually corresponding micro-entry optical units 310 and micro-exit optical units 320 coincide. In this manner, the optical imaging system may be formed from a plurality of micro-optical systems.

If each individual segment 330 is controllable with regards to its transparency independently of the other segments, the segments 330 can be controlled in such a manner that, for example, a first part of the segments 330 is used such that the motor-vehicle headlamp light module 1 generates a light distribution of a first predefined type, and a second part of the segments 330 is used such that the motor-vehicle headlamp light module 1 generates a light distribution of a second predefined type. Furthermore, it is conceivable that the control of the segments 330 takes place in a correlated manner, for example. In this case, the segments 330 can be controlled either individually or in groups, wherein, accordingly, the control either of the individual segments 330 or the groups of segments can be adapted to one another. Each group of segments 330 may also be controlled in dependence on the light source(s) assigned to this group of segments 330 or the corresponding group of micro-imaging systems.

In this manner, it is for example possible to generate various dynamic, legally prescribed, light distributions simultaneously or alternately, but also to realize welcome and/or warning scenarios. For example, a short flashing of a pattern generated by the light module may be considered in this case. It is also conceivable for a dynamic pattern, which changes fast within a few seconds, without changing the light function (e.g. dipped beam, main beam or town light) of the motor-vehicle headlamp light module 1—i.e. the total light distribution (e.g. dipped beam, main beam or town light distribution) generated by the motor-vehicle headlamp light module 1. Thus, sequenced flashing light effects may be created/realized for an observer for example, but the radiated light distribution (total light distribution) may remain the same. For further details about such so-called illumination structures, reference may be made at this point to an Austrian patent application of the applicant, AT 517308 A1. For example, a sequenced flashing light effect similar to a “dynamic direction indicator”, which is realized today in the case of indicators by successive switching on of LEDs arranged in a row, is possible with unchanged dipped-beam function and/or “welcome-light” functions, such as the stylized opening and closing of the motor vehicle headlamps (the “eyes” of the vehicle), etc.

Furthermore, it can be drawn from FIG. 2, that each individual segment 330 may comprise subsegments, for example liquid-crystal-display subsegments. FIG. 2 shows a liquid-crystal-display segment, which has five liquid-crystal-display subsegments 331 to 335. The liquid-crystal-display subsegments 331 to 335 have different shapes and are of different sizes. Generally, the liquid-crystal-display subsegments are set up to control or to check a radiated light quantity into a particular region of a light distribution generated by the motor-vehicle headlamp light module. In this sense, the subsegments, for example the liquid-crystal-display subsegments 331 to 335 correspond to certain regions of a light distribution generated by the motor-vehicle headlamp light module. For example, the person skilled in the art undoubtedly recognizes that an edge 3330 of a liquid-crystal-display subsegment 333 of FIG. 2 is provided for imaging a part of an asymmetrically running cut-off line of a dipped-beam distribution. A further liquid-crystal-display subsegment 334 can for example be provided for generating what is known as a sign-light distribution, that is to say a light distribution for illuminating traffic signs above the carriageway. It is indicated at this point, that a sign-light distribution is illuminated on a measuring screen (set up at an approx. 25 metre distance in front of a motor-vehicle headlamp light module or motor vehicle headlamp to be tested, transversely to the optical axis thereof) in a lighting engineering laboratory, preferably an upper region of the zone III according to ECE-R123.

In order, for example, to achieve a high flexibility in the selection of the type of the light distribution to be generated, it is expedient if each subsegment is controllable individually and preferably independently of one another with regards to the transparency thereof. With the aid of the liquid crystal display 33 illustrated in FIG. 2, a dipped-beam distribution can for example be generated, in that the liquid-crystal-display subsegments 331 and 332 are operated in a fully transparent (light-permeable) mode, i.e. transmit light hitting them completely, and the liquid-crystal-display subsegments 333 to 335 block the light completely, i.e. are completely non-light-permeable. In this case, one can supplement the dipped-beam distribution with the above-mentioned sign light distribution if the transparency of the liquid-crystal-display subsegment 334 is increased a little and this allows through approximately 1 to 2% of the incident light. The person skilled in the art can directly and clearly draw from the disclosure of FIG. 2, that with the aid of such a liquid crystal display 33, other light distributions, for example a sign-light distribution, which is provided for example for illuminating traffic signs attached above the carriageway, or a main-beam distribution, can also be realized. It is understood that not all segments 330 have to have a uniform division of the subsegments 331 to 335. Depending on the light distribution, for example total light distribution, to be realized, it may advantageous that a first part of the liquid crystal display 33 has segments with a first division of the segments into subsegments, a second part of the liquid crystal display 33 has segments with a second division of the segments into subsegments, and so on.

Returning to FIG. 1, this shows the entry optical unit 31 with the micro-entry optical units 310 arranged in an array. That is to say, the arrangement of the micro-entry optical units 310 is matrix-like and for example has N horizontal (lines) and M vertical rows. The exit optical unit 32 is likewise formed from micro-exit optical units 320 arranged in an array. The micro-exit optical unit array for example has N1 horizontal (lines) and M1 vertical rows, wherein N=N1 and/or M=M1 is preferably true. The micro-entry optical units 310 and the micro-exit optical units 320 are preferably assigned to one another in groups. In this case, “in groups” means that at least one micro-exit optical unit 320 is assigned to at least one micro-entry optical unit 310 in such a manner that the light passing through the at least one micro-entry optical unit 310 can penetrate only to the at least micro-exit optical unit 320 assigned to the at least one micro-entry optical unit 310 and preferably does not reach other micro-exit optical units 320 not assigned to the at least one micro-entry optical unit 310. Different assignments relating to the number of micro-entry optical units and micro-exit optical units are conceivable here. For example, a single micro-exit optical unit may be assigned to a group made up of four or nine or more micro-entry optical units and vice versa. FIG. 1 shows a case, in which precisely one micro-exit optical unit is assigned to precisely one micro-entry optical unit 310. An optical micro-imaging system can be defined with the aid of this assignment. This optical micro-imaging system for example comprises a first group of micro-entry optical units, a second group of micro-exit optical units assigned to the first group, and at least one segment of the continuous layer, which is controllable with regards to its transparency. In this case, the term “group” does not exclude the number “1”. The group may therefore consist of a single element.

FIG. 1 shows eight light sources 2. As the person skilled in the art may directly And clearly draw from the present documents, a light module according to the invention may also comprise a different number of light sources. It may be very useful if each light source is set up for generating a predetermined light distribution. For the purpose of generating light distributions of various predefined types, it may be advantageous if the optical imaging system 3 has a plurality of different regions, wherein each region is preferably assigned to precisely one light source 3 and set up for shaping/imaging a light distribution of a predefined type. In this case, different regions of the optical imaging system 3 may be set up for shaping/imaging light distributions of different predefined types. Furthermore, different light sources may radiate light in different colours (it is e.g. conceivable to use amber-coloured light-emitting diodes (LEDs) in addition to the light sources in other colours, such as white (from warm up to cold) or blue). This may for example be useful if one thinks to realize both an indicator function and a daytime-running-light function or a dipped-beam function with the aid of the motor-vehicle headlamp light module 1.

In practice, it may be useful, if at least part of the light sources is controllable independently of the other light sources.

The motor-vehicle headlamp light module 1 may for example be set up to generate a plurality of light distributions, wherein the type of each light distribution is chosen from the following list of types:
cornering light distribution;
town light distribution;
country light distribution;
motorway light distribution;
light distribution for booster light for motorway light;
cornering-beam light distribution;
dipped-beam light distribution;
near field dipped-beam light distribution;
light distribution for asymmetric far field dipped beam;
light distribution for asymmetric far field dipped beam in cornering-beam mode;
main-beam light distribution;
indicator light distribution;
position light distribution;
anti-glare main-beam light distribution;
flashing-light-sequence-effect light distribution.

With reference to the above-mentioned control device 5, it is understood that the control device 5 may be set up for controlling the transparency of the segments 330 and/or the subsegments 331 to 335 of the continuous layer 33, for example the liquid crystal display. In particular, the control device 5 may be set up to control the individual segments 330 and/or subsegments 331 to 335 individually and preferably independently of one another.

In summary, it is possible, using the present invention, to achieve an increase in the functionality of a light module, particularly if the entry optical unit and the exit optical unit are constructed as microlens arrays. In the last case, identical micro-light images (micro-light distributions) can be generated with the aid of micro-optical systems (micro-imaging systems) for example, which micro-light images together form the total light image (total light distribution), wherein it is possible to illuminate each segment with lower intensity compared to a conventional light module, in which only a single projection module must generate the entire light distribution. As a result, thermal loading of the continuous layer, which is constructed as LC element (liquid crystal display) for example, may for example be reduced as a result. Furthermore, the light module according to the invention may generate a plurality of light distributions of different types, wherein the light forming these light distributions exits from precisely one exit optical unit, i.e. from a common micro-exit optical unit array—for various light distributions. This not only leads to the available installation space being better utilized owing to the division of the light exit surface, but also to a better impression being created for the observer.

Furthermore, optically attractive and at the same time highly functional lighting solutions can be created in the field of motor-vehicle lighting engineering.

Furthermore, in the case of a constant light image—with constant light distribution generated with the aid of the light module—the light module itself may be animated. For example, a sequenced flashing light effect, similar to a “dynamic direction indicator” with unchanged dipped-beam function, “welcome-light” functions, such as for example the stylized opening and closing of the “eyes” of the vehicle, etc.

On the basis of the description of the figures and the description introduction, it is of course clear to the person skilled in the art that a ready-for-use light module or motor vehicle headlamp with an above-mentioned light module may have other parts, such as for example heat sinks, supporting frames, mechanical and/or electrical adjusting devices, covers and so on. Furthermore, the mode of operation of these parts is known to the person skilled in the art. For the sake of the simplicity of the illustration, the description of these standard components of a motor vehicle light module or motor vehicle headlamp is dispensed with here.

The object of this description only consists in providing illustrative examples and specifying further advantages and characteristic features of the present invention, and thus it cannot be interpreted as a limitation of the field of application of the invention or the patent rights claimed in the claims.

The reference numbers in the claims and in the description are used solely for better understanding of the present application and should in no way be considered as a limitation of the subject matter of the present invention.

Furthermore, although the description of the invention contains the description of one or more embodiments and certain variations and modifications, other variations and modifications lie within the scope of the invention, e.g. within the capabilities and knowledge of persons skilled in the art after understanding the present disclosure.

Insofar as it does not necessarily result from the description of one of the above-mentioned embodiments, it is assumed that the described embodiments can be combined with one another as desired. Among other things, this means that the technical features of an embodiment with the technical features of a different embodiment can be combined individually and independently of one another as desired, in order to achieve a further embodiment of the same invention in this manner.

1. A light module for a motor vehicle headlamp, which light module comprises:
at least one light source (2), and
at least one optical imaging system (3), which optical imaging system (3) is configured to image light generated by the at least one light source (2) into a region in front of the light module (1) in the form of at least one light distribution of a predefined type, wherein the optical imaging system (3) has:
an entry optical unit (31)
an exit optical unit (32), and
at least one beam-shaping device (33), wherein the beam-shaping device (33) is arranged between the entry optical unit (31) and the exit optical unit (32), wherein:
the entry optical unit (31) is configured to capture the light generated by the at least one light source (2) and to conduct the same in the form of a plurality of light bundles in the direction of the beam-shaping device (33),
the beam-shaping device (33) is configured to shape the plurality of light bundles to form at least one intermediate image of a predefined type, and
the exit optical unit (32) is configured to project the at least one intermediate image of a predefined type, in the form of the at least one light distribution of a predefined type, into the one region in front of the light module (1);
wherein:
the beam-shaping device (33) is constructed as a continuous layer extending in a plane which is transverse to the optical axis (OA) of the optical imaging system (3),
wherein the continuous layer is controllable with regards to its transparency and the total light quantity penetrating from the entry optical unit (31) to the exit optical unit (32) can be influenced by adjusting the transparency of the continuous layer,
the continuous layer has one, two or more segments (330) lying in the same plane,
each individual segment is controllable independently of the other segments (330) with regards to its transparency, wherein
the entry optical unit (31) is constructed as a plurality of micro-entry optical units (310),
the exit optical unit (32) is constructed as a plurality of micro-exit optical units (320),
the micro-entry optical units (310) and the micro-exit optical units (320) are assigned to one another in groups, and define a multiplicity of optical micro-imaging systems, wherein each optical micro-imaging system comprises a group of micro-entry optical units (310), a group of micro-exit optical units (320) and at least one segment (330) of the continuous layer (33), which is controllable with regards to its transparency,
the light module (1) comprises a plurality of light sources (2) which are controllable independently of one another, and
at least a first part of the segments (330) is configured to generate a light distribution of a first predefined type, and at least one second part of the segments (330) is configured to generate a light distribution of a second predefined type.

2. The light module according to claim 1, wherein the continuous layer is constructed as a liquid crystal layer (33).

3. The light module according to claim 1, wherein all segments (330) lie in a vertical plane and adjoin one another.

4. The light module according to claim 1, wherein each individual segment (330) comprises at least one subsegment (331 to 335) and the at least one subsegment is controllable with regards to its transparency.

5. The light module according to claim 4, wherein each individual segment (330) comprises two or more subsegments (331 to 335), which lie in the same plane, wherein the subsegments (331 to 335) are controllable independently of one another.

6. The light module according to claim 5, wherein the subsegments (331 to 335) have a different shape and/or size.

7. The light module according to claim 1, wherein each micro-imaging system has precisely one micro-entry optical unit (310), precisely one micro-exit optical unit (320) and precisely one segment (330) of the continuous layer (33), which is controllable with regards to its transparency.

8. The light module according to claim 1, wherein a collimator (4) is installed upstream of each light source (2) and each light source (2) is configured to generate a predefined light distribution.

9. The light module according to claim 1, wherein the light sources (2) are arranged on a printed circuit board.

10. The light module according to claim 1, wherein the light module (1) is configured to generate a plurality of light distributions, wherein each light distribution of the plurality of light distributions is chosen from the following types:
a cornering light distribution;
a town light distribution;
a country light distribution;
a motorway light distribution;
a light distribution for booster light for motorway light;
a cornering-beam light distribution;
a dipped-beam light distribution;
a near field dipped-beam light distribution;
a light distribution for asymmetric far field dipped beam;
a light distribution for asymmetric far field dipped beam in cornering-beam mode;
a main-beam light distribution;
a indicator light distribution;
a position light distribution;
a anti-glare main-beam light distribution; and
a flashing-light-sequence-effect light distribution.

11. The light module according to claim 1, wherein a control device (5) is assigned to the light module (1), which control device (5) is configured to control the transparency of the continuous layer (33).

12. A motor vehicle headlamp having at least one light module according to claim 1.

13. The light module according to claim 2, wherein the liquid crystal layer (33) is a liquid crystal display.

14. The light module according to claim 5, wherein each individual segment (330) comprises five subsegments (331 to 335).

15. The light module according to claim 5, wherein the subsegments (331 to 335), adjoin one another.

16. The light module according to claim 5, wherein each individual segment (330) comprises five subsegments (331 to 335) which adjoin one another.

17. The light module according to claim 9, wherein the printed circuit board is arranged transversely to a main radiation axis of the light module (1).

18. The light module according to claim 9, wherein the light sources (2) are arranged on the printed circuit board in a 4×3 matrix-like arrangement.

19. The light module according to claim 9, wherein the light sources (2) are configured to radiate light in different colours.

20. The light module according to claim 11, wherein the control device (33) is arranged in the light module (1).
